(19) United States
(12) Patent Application Publication
(10) Pub. No.: US 2025/0110731 A1
(43) Pub. Date: Apr. 3, 2025

(54) Structural Code Refactoring Based On The User's Code Changes Using Large Language Models

(71) Applicant: Google LLC, Mountain View, CA (US)

(72) Inventors: Mateusz Lewko, Adliswil (CH); Marko Ivankovic, Obfelden (CH); Luka Rimanic, Zurich (CH)

(73) Assignee: Google LLC, Mountain View, CA (US)

(21) Appl. No.: 18/478,394

(22) Filed: Sep. 29, 2023

(51) Int. Cl. G06F 8/72; G06F 8/51

(52) U.S. Cl. CPC G06F 8/72; G06F 8/51

(57) ABSTRACT

A computer-implemented method includes receiving an original code snapshot corresponding to original code from a first file of a plurality of files. The method also includes receiving a modified code snapshot corresponding to modified code that includes a code modification modifying the original code. The method also includes generating, using a large language model (LLM), refactoring code based on the original code snapshot and the modified code snapshot. The refactoring code is configured to apply the code modification to code from other files of the plurality of files associated with the original code. The method also includes identifying target code from a second file of the plurality of files where the target code is associated with the original code. The method also includes applying the code modification to the identified target code using the refactoring code.

### TECHNICAL FIELD

This disclosure relates to structural code refactoring based on the user's code changes using large language models.

### BACKGROUND

Refactoring code is the process of restructuring code without changing the function of the code. Refactoring code is a well-established obstacle when writing code during software development and management. The need for refactoring code is proportional to an amount of technical debt in a particular codebase. In some instances, refactoring code involves simplifying the code or improving a robustness of the code without changing the code functionality. Current approaches for refactoring code include tools that are either not powerful enough to handle large codebases or too time consuming for programmers to learn how to use the tool effectively. As such, programmers often defer refactoring code, sometimes indefinitely, because of the substantial effort required with the currently available tools.

### SUMMARY

One aspect of the disclosure provides a computer-implemented method that when executed on data processing hardware causes the data processing hardware to perform operations for structural code refactoring based on code changes using large language models. The operations include receiving an original code snapshot corresponding to original code from a first file of a plurality of files and receiving a modified code snapshot corresponding to modified code from the first file of the plurality of files. Here, the modified code includes a code modification modifying the original code. The operations also include generating, using a large language model (LLM), refactoring code based on the original code snapshot and the modified code snapshot. The refactoring code is configured to apply the code modification to code from other files of the plurality of files associated with the original code. The operations also include identifying target code from a second file of the plurality of files where the target code is associated with the original code. The operations also include applying, using the refactoring code, the code modification to the identified target code of the second file of the plurality of files.

Implementations of the disclosure may include one or more of the following optional features. In some implementations, a code functionality of the original code is the same as a code functionality of the modified code. In some examples, the original code and the modified code each include respective code in a first programming language and the refactoring code includes code in a second programming language different from the first programming language. In these examples, the second programming language may include a design specific language (DSL). Before applying the code modification to the identified target code, the operations may further include displaying the refactoring code via a user device associated with a user, receiving updated refactoring code including a user modification from the user device associated with the user, and applying the code modification to the identified target code using the updated refactoring code.

In some implementations, the LLM includes a pre-trained LLM. In some examples, the operations further include training the LLM using labeled training samples. Here, each respective labeled training sample includes a corresponding training input paired with ground-truth refactoring code where the corresponding training input includes training original code and training modified code. In these examples, training the LLM using labeled training samples may include, for each respective labeled training sample, generating predicted refactoring code based on the corresponding training input using the LLM, determining a training loss based on the predicted refactoring code and the paired ground-truth refactoring code, and training the LLM based on the training loss. The ground-truth refactoring code may include placeholders for capture variables. In some implementations, the operations further include determining a first Abstract Syntax Tree (AST) based on the original code snapshot, determining a second AST based on the modified code snapshot, and generating a comparison between the first AST with the second AST. Here, the refactoring code generalizes the comparison between the first AST and the second AST.

Another aspect of the disclosure provides a system that includes data processing hardware and memory hardware storing instructions that when executed on the data processing hardware causes the data processing hardware to perform operations. The operations include receiving an original code snapshot corresponding to original code from a first file of a plurality of files and receiving a modified code snapshot corresponding to modified code from the first file of the plurality of files. Here, the modified code includes a code modification modifying the original code. The operations also include generating, using a large language model (LLM), refactoring code based on the original code snapshot and the modified code snapshot. The refactoring code is configured to apply the code modification to code from other files of the plurality of files associated with the original code. The operations also include identifying target code from a second file of the plurality of files where the target code is associated with the original code. The operations also include applying, using the refactoring code, the code modification to the identified target code of the second file of the plurality of files.

Implementations of the disclosure may include one or more of the following optional features. In some implementations, a code functionality of the original code is the same as a code functionality of the modified code. In some examples, the original code and the modified code each include respective code in a first programming language and the refactoring code includes code in a second programming language different from the first programming language. In these examples, the second programming language may include a design specific language (DSL). Before applying the code modification to the identified target code, the operations may further include displaying the refactoring code via a user device associated with a user, receiving updated refactoring code including a user modification from the user device associated with the user, and applying the code modification to the identified target code using the updated refactoring code.

In some implementations, the LLM includes a pre-trained LLM. In some examples, the operations further include training the LLM using labeled training samples. Here, each respective labeled training sample includes a corresponding training input paired with ground-truth refactoring code where the corresponding training input includes training original code and training modified code. In these examples, training the LLM using labeled training samples may include, for each respective labeled training sample, generating predicted refactoring code based on the corresponding training input using the LLM, determining a training loss based on the predicted refactoring code and the paired ground-truth refactoring code, and training the LLM based on the training loss. The ground-truth refactoring code may include placeholders for capture variables. In some implementations, the operations further include determining a first Abstract Syntax Tree (AST) based on the original code snapshot, determining a second AST based on the modified code snapshot, and generating a comparison between the first AST with the second AST. Here, the refactoring code generalizes the comparison between the first AST and the second AST.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system using a refactoring assistant.

FIG. 2 is a schematic view of an example process for training a large language model.

FIG. 3 is a flowchart of an example arrangement of operations for a computer-implemented method of performing structural code refactoring based on code changes using large language models.

FIG. 4 is a schematic view of an example computing device that may be used to implement the systems and methods described herein.

Like reference symbols in the various drawings indicate like elements.

### DETAILED DESCRIPTION

With the rapid advancement of software-related technologies, programmers often prioritize delivering software applications expeditiously over the quality of code for these software applications. Thus, at some point during a lifetime of many software applications, code refactoring is required to improve upon the initial quality of the code. Yet, programmers usually defer, or never perform, code refactoring due to the significant effort required to do so with currently available refactoring tools. In particular, currently available refactoring tools are either not powerful enough to refactor large codebases and/or learning how to use the tools requires too much time and effort for the programmers to learn. For instance, the refactoring tools may use a unique programming language that is different from the programming language the software application is written with, such that the programmer is unfamiliar with the unique programming language. Consequently, many software applications have instances of quality issues or code rot with the code because of the deficiencies of current refactoring tools.

Accordingly, implementations herein are directed towards methods and systems for performing structural code refactoring based on the code changes using large language models. In particular, a refactoring assistant receives an original code snapshot corresponding to original code (e.g., code before refactoring is performed) a modified code snapshot (e.g., code after refactoring is performed) that includes a code medication modifying the original code. The refactoring assistant uses a large language model (LLM) to generate refactoring code based on the original code snapshot and the modified code snapshot. Here, the refactoring code is configured to apply the code modification to other files that include the same or similar code as the original code of the original code snapshot. To that end, the refactoring assistant identifies target code from the other files associated with the original code and applies the code modification to the identified target code using the refactoring code generated by the LLM.

Advantageously, a user may make a single code modification and the refactoring assistant identifies other instances of code that the code modification could be applied to and applies the generated refactoring code to the identified instances of code. Simply put, the user makes the single code modification and the refactoring assistant identifies and applies the code modification to related instances of code within a same file or a different file without requiring any further input from the user. As such, the refactoring assistant is particularly useful for refactoring codebases that require a same code change in multiple different instances throughout the code.

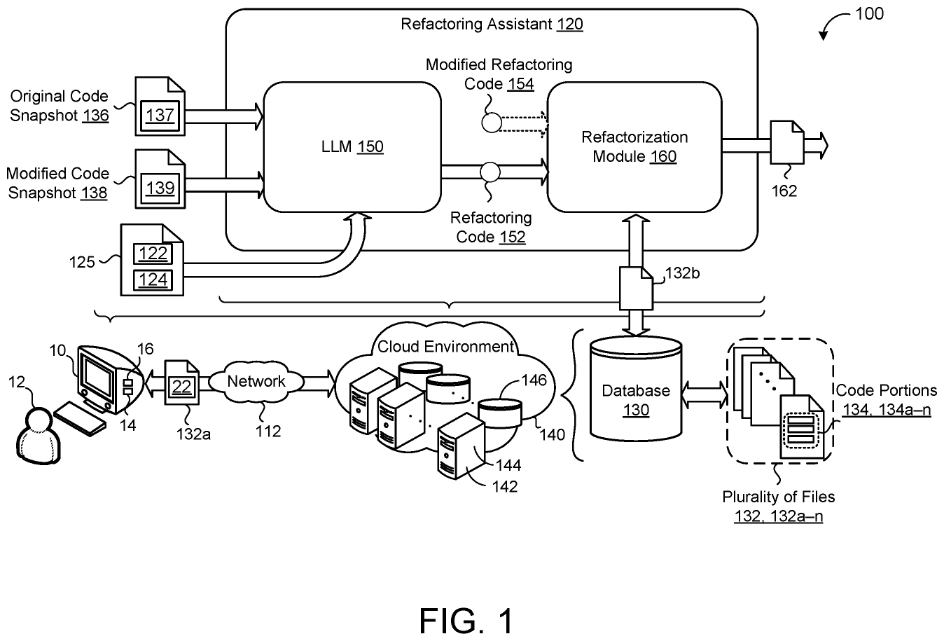

Referring to FIG. 1, in some implementations, an example system 100 includes a user device 10 associated with a respective user 12 in communication with a cloud computing environment (e.g., remote system) 140 via a network 112. The user device 10 may correspond to any computing device, such as a desktop workstation, a laptop workstation, or a mobile device (i.e., a smart phone). The user device 10 includes computing resource 14 (e.g., data processing hardware) and/or storage resources 16 (e.g., memory hardware).

The cloud computing environment 140 may be a single computer, multiple computers, or a distributed system having scalable/elastic resources 142 including computing resources 144 (e.g. data processing hardware) and/or storage resources 146 (e.g., memory hardware). A database 130 or multiple databases 130 may be overlain on the storage resources 146 to allow scalable use of the storage resources 146 by one or more of the user or computing resources 144. However, the database 130 may be overlain on the storage resources 16 of the user device 10 in addition to, or in lieu of, the storage resources 146 of the cloud computing environment 140. The database 130 is configured to store a plurality of files 132, 132a-n each having one or more code portions 134, 134a-n. Here, each file 132 includes code in any suitable programming language. Moreover, each code portion 134 of a respective file 132 refers to a particular section of code from the respective file 132. In the example shown, the one or more code portions 134 includes three code portions 134 for the sake of clarity only, as files 132 may include any number of code portions 134.

The user 12 may interact, via the user device 10, with the database 130 to modify code of any of the plurality of files 132 or, more specifically, any of the code portions 134 from the files 132. For instance, the user device 10 may obtain one of the files 132 (e.g., from the storage resources 16, 146) and modify one or more code portions 134 of the obtained file 132. In the example shown, the user device 10 obtains a first file 132 from the plurality of files 132 and generates a code modification 22 for the first file 132. The code modification 22 may include, but is not limited to, adding code to the first file 132, deleting code from the first file 132, refactoring code from the first file 132, and/or editing existing code from the first file 132. Here, refactoring code refers to editing code without changing a functionality of the code. For instance, a refactoring code modification 22 may include replacing code for object initialization with code for a function call, replacing for loop code with generic function calls that encapsulate an algorithm implemented with the for loop, modifying an order of function arguments, and/or replacing multiple function calls or simple algorithms with a code snippet. Continuing with the example shown, the database 130 receives the first file 132a and the code modification 22 and updates the stored first file 132a with the code modification 22.

In some scenarios, the user 12 generates the code modification 22 for a single instance of code (e.g., a single code portion 134 from a single file 132) while multiple other similar instances of code exist within the database 130 that could benefit from the same code modification 22. In some conventional systems, the user 12 is required to manually identify and modify the code from the multiple other similar instances to refactor the code across the database 130. In other conventional systems, the user 12 is required to manually write additional code that identifies the other similar instances and modifies the associated code. As such, the conventional systems require significant manual input and knowledge from the user 12 to apply the code modification 22 throughout the database 130.

To that end, the data processing hardware 14 of the user device 10 and/or the data processing hardware 144 of the cloud computing environment 140 executes a refactoring assistant 120 configured to refactor code for the plurality of files 132 stored at the database 130 based on the code modification 22 received from the user device 10. In particular, the refactoring assistant 120 may detect whether the user 12, via the user device 10, modifies code for any of the plurality of files 132 stored at the database 130. For example, the refactoring assistant 120 detects that the user 12 modified code based on detecting the code modification 22 received from the user device 10.

In response to detecting that code for a file 132 has been modified, the refactoring assistant 120 obtains or receives an original code snapshot 136 and a modified code snapshot 138. In some examples, the refactoring assistant 120 obtains the original code snapshot 136 and the modified code snapshot 138 from the database 130. Here, the original code snapshot 136 corresponds to original code 137 from a respective one of the plurality of files 132 (e.g., code before the code modification 22 was applied to the file 132) and the modified code snapshot 138 corresponds to modified code 139 from the respective one of the plurality of files 132 (e.g., code after the code modification 22 is applied to the file 132). As used herein, the original code 137 refers to code from any of the files 132 before any applied code modification 22 and the modified code 139 refers to code after applying the code modification 22. Stated differently, the modified code 139 of the modified code snapshot 138 includes the code modification 22 modifying the original code 137 and/or representing a modified version of the original code 137. The code functionality of the original code 137 may be the same as the code functionality of the modified code 139. In some implementations, the original code snapshot 136 and the modified code snapshot 138 each correspond to a respective code portion 134 from the respective one of the files 132. In other implementations, the original code snapshot 136 and the modified code snapshot 138 each correspond to an entirety of the respective one of the files 132.

The refactoring assistant 120 employs a large language model (LLM) 150 or other model that is configured to receive, as input, the original code snapshot 136 and the modified code snapshot 138 and generate, as output, refactoring code 152. The LLM 150 may be a pretrained LLM. In some examples, the original code 137 and the modified code 139 each include code in a first programming language and the refactoring code 152 includes code in a second programming language that is different from the first programming language. For instance, the second programming language may be a design specific language (DSL) uniquely associated with a refactoring tool. Thus, the user 12 may or may not be familiar or proficient with the second programming language.

The refactoring code 152 is configured to apply the code modification 22 to code from other files 132 of the plurality of files 132 associated with the original code 137. That is, the refactoring assistant 120 applies the code modification 22 (e.g., received from the user device 10 for a respective one of the files 132) to other files 132 from the plurality of files 132 using the refactoring code 152 generated by the LLM 150. Advantageously, the refactoring assistant 120 applies the code modification 22 using the refactoring code 152 without requiring additional input from the user 12. More specifically, based on receiving the code modification 22, the refactoring assistant 120 identifies other files 132 that include the same or similar original code 137 and applies the code modification 22 using the refactoring code 152 without additional user input. In some examples, the user 12 generates the code modification 22 for a respective file 132 and the refactoring assistant 120 applies the code modification 22 to one or more other files 132 from the plurality of files 132. In other examples, the user 12 generates the code modification 22 for a respective code portion 134 of a respective file 132 and the refactoring assistant 120 applies the code modification 22 to one or more other code portions 134 from the respective file 132 and/or other files 132.

In the example shown, the refactoring assistant 120 obtains the original code snapshot 136 that includes the original code 137 associated with the first file 132a before the code modification 22 is applied and the modified code snapshot 138 that includes the modified code 139 associated with the first file 132a after the code modification 22 generated by the user 12 is applied to the first file 132a. Using the original code snapshot 136 and the modified code snapshot 138, the LLM 150 generates the refactoring code 152 that is configured to apply the same code modification 22 received from the user device 10 for the first file 132a to one or more other files 132.

In some implementations, the LLM 150 outputs the refactoring code 152 directly to a refactorization module 160. In other implementations, the refactoring assistant 120 may optionally display the refactoring code 152 to the user 12 (e.g., via a screen of the user device 10) before using the refactoring code 152. For instance, the user 12 may be experienced with the DSL of the refactoring code 152 and wish to review and/or edit the refactoring code 152 before the refactoring assistant 120 applies the code modification 22 using the refactoring code. Thus, in these instances, the refactoring assistant 120 may receive updated refactoring code 154 from the user device 10 that includes a user modification to the LLM 150 generated refactoring code 152 and use the updated refactoring code 154 in lieu of the LLM 150 generated refactoring code 152.

In some examples, the refactoring assistant 120 determines a first Abstract Syntax Tree (AST) 122 based on the original code snapshot 136 and determines a second AST 124 based on the modified code snapshot. Thereafter, the refactoring assistant 120 generates a comparison 125 between the first AST 122 and the second AST 124. Here, the refactoring code 152 generated by the LLM 150 may generalize the comparison 125 between the first AST 122 and the second AST 124. That is, the comparison 125 between the first AST 122 and the second AST 124 summarizes the differences between the original code snapshot 136 and the modified code snapshot 138 such that the LLM 150 may generate the refactoring code 152 based on the comparison 125 in addition to, or in lieu of, the original code snapshot 136 and the modified code snapshot 138.

The refactoring assistant 120 employs a refactorization module 160 that is configured to receive, as input, the refactoring code 152 generated by the LLM 150 based on the original code snapshot 136 and the modified code snapshot 138, and identify target code from one or more other files 132 stored at the database 130. That is, target code identified by the refactorization module 160 is code that is the same or sufficiently similar (i.e., satisfies a threshold value) to the original code 137 modified by the code modification 22 received from the user device 10. Thus, the refactorization module 160 may identify other code portions 134 from the same respective file 132 modified by the user 12 and/or other files 132 stored at the database 130. The refactorization module 160 may identify any number of code portions 134 and/or files 132 that include or are sufficiently similar to the original code 137. In some examples, the refactoring assistant 120 prompts the user 12 to allow or deny the refactoring assistant 120 from using the refactoring code 152 on the identified target code. After identifying the target code from another file 132, the refactorization module 160 applies the code modification 22 to the identified target code using the refactoring code 152 and outputs a refactored code file 162 (also referred to as a refactored code portion 162). The refactoring assistant 120 may output the refactored code file 162 to the database 130 and update or replace the associated file 132 with the refactored code file 162 that include the code modification 22.

Referring again to the example shown, the refactorization module 160 identifies the target code from a second file 132b of the plurality of files 132 that includes code associated with the original code 137. Thus, the refactorization module 160 applies the refactoring code 152 to the second file 132b to generate the refactored code file 162 whereby the refactored code file 162 may replace or update the second file 132b stored at the database 130. Advantageously, the user 12 generated the code modification 22 only for the first file 132a and the refactoring assistant 120 applied the code modification 22 to the second file 132b (and any number of subsequent files 132) using refactoring code 152 generated by the LLM 150 without the user 12 identifying or modifying the second file 132b.

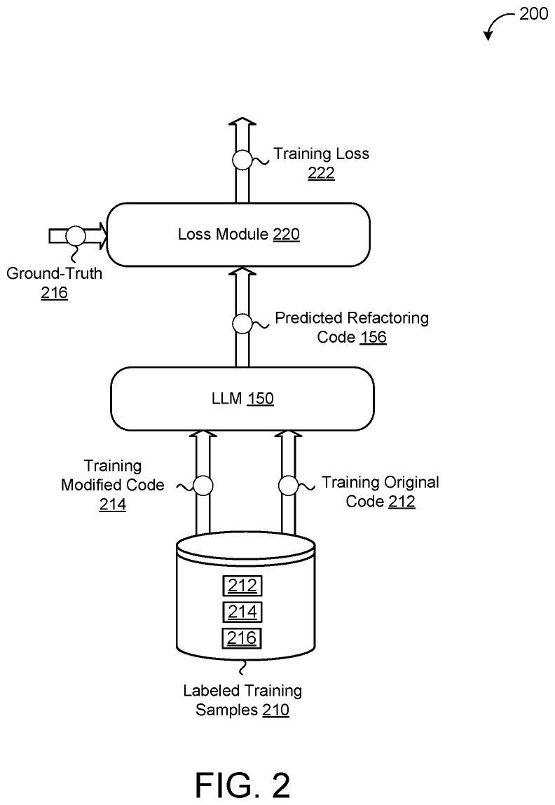

FIG. 2 illustrates an example training process 200 for training the LLM 150. In some examples, the LLM 150 is a pre-trained LLM whereby the training process 200 fine-tunes the LLM 150 with few-shot learning. Put another way, the LLM 150 may be a trained generalized LLM and the training process 200 trains the LLM 150 specifically to generate accurate refactoring code. That is, the training process 200 trains the LLM 150 using labeled training samples 210 that include a limited number (i.e., few-shot) labeled training samples 210. Each labeled training sample 210 includes a corresponding training input 212, 214 paired with ground-truth refactoring code 216. Moreover, the training input 212, 214 includes training original code 212 corresponding to code before any code modifications are applied and training modified code 214 corresponding to code after code modifications are applied.

The LLM 150 receives the training input 212, 214 for each respective labeled training sample 210 and generates predicted refactoring code 156 based on the corresponding training input 212, 214. The LLM 150 outputs the predicted refactoring code 156 to a loss module 220 that determines a training loss 222 based on the predicted refactoring code 156 and the paired ground-truth refactoring code 216 for the respective labeled training sample 210. The training process 200 trains the LLM 150 based on the training loss 222 determined for each labeled training sample 210. In some examples, the ground-truth refactoring code 216 includes placeholders for capture variables. That is, the placeholders may be in the form of “<number>” or “<name>” to generalize capture variables in code. Here, capture variables may refer to variables (e.g., values) or names specific to the training input 212, 214 such that the LLM 150 does not need to generate refactoring code 152 to match the capture variables of the training input 212, 214 during inference.

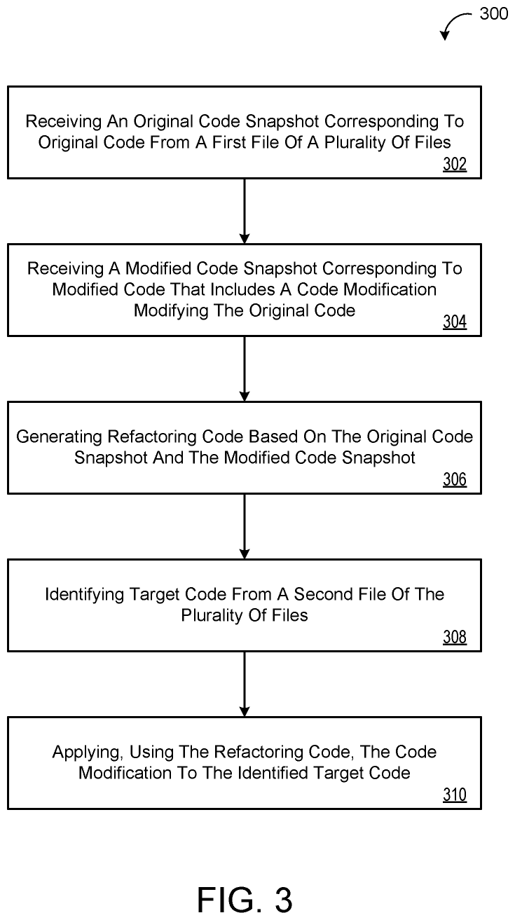

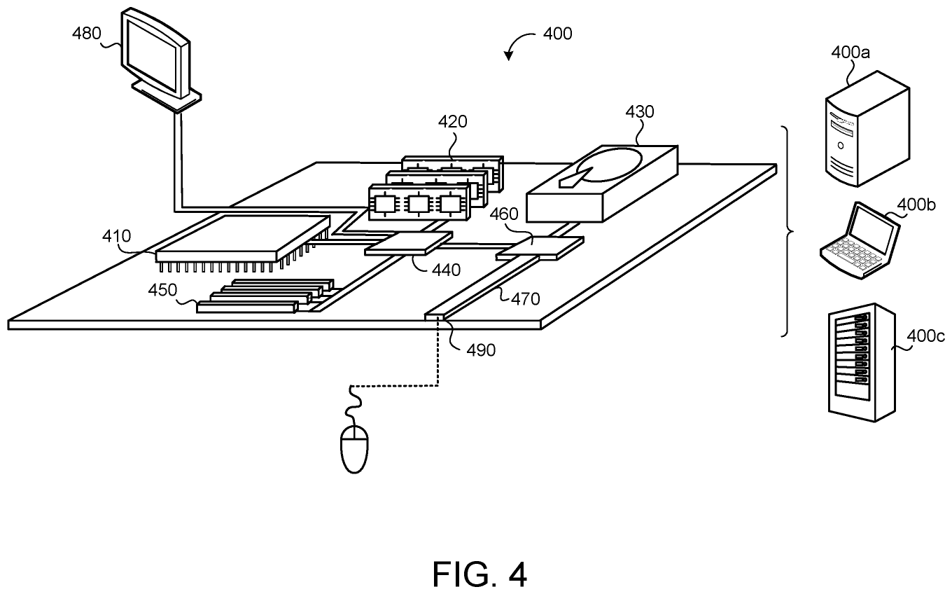

FIG. 3 is a flowchart of an example arrangement of operations for a computer-implemented method 300 of structural code refactoring based on code changes using large language models. The method 300 may execute on data processing hardware 410 (FIG. 4) based on instructions stored on memory hardware 420 (FIG. 4) in communication with the data processing hardware 410. The data processing hardware 410 and the memory hardware 420 may reside on the user device 10 and/or the cloud computing environment 140 of FIG. 1 corresponding to a computing device 400 (FIG. 4).

At operation 302, the method 300 includes receiving an original code snapshot 136 corresponding to original code 137 from a first file 132a of a plurality of files 132. At operation 304, the method 300 includes receiving a modified code snapshot 138 corresponding to modified code 139 from the first file 132a of the plurality of files 132. Here, the modified code 139 includes a code modification 22 modifying the original code 137. At operation 306, the method 300 includes generating, using a large language model (LLM) 150, refactoring code 152 based on the original code snapshot 136 and the modified code snapshot 138. The refactoring code 152 is configured to apply the code modification 22 to code from other files 132 of the plurality of files 132 associated with the original code 137. At operation 308, the method 300 includes identifying target code from a second file 132b of the plurality of files 132. In particular, the target code is associated with the original code 137. At operation 310, the method 300 includes applying, using the refactoring code 152, the code modification 22 to the identified target code of the second file 132b of the plurality of files 132.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

FIG. 4 is a schematic view of an example computing device 400 that may be used to implement the systems and methods described in this document. The computing device 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 400 includes a processor 410, memory 420, a storage device 430, a high-speed interface/controller 440 connecting to the memory 420 and high-speed expansion ports 450, and a low speed interface/controller 460 connecting to a low speed bus 470 and a storage device 430. Each of the components 410, 420, 430, 440, 450, and 460, are interconnected using various busses, and may be mounted on a common motherboard or in other manners as appropriate. The processor 410 can process instructions for execution within the computing device 400, including instructions stored in the memory 420 or on the storage device 430 to display graphical information for a graphical user interface (GUI) on an external input/output device, such as display 480 coupled to high speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 420 stores information non-transitorily within the computing device 400. The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 420, the storage device 430, or memory on processor 410.

The high speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method that when executed on data processing hardware causes the data processing hardware to perform operations comprising:
receiving an original code snapshot corresponding to original code from a first file of a plurality of files;
receiving a modified code snapshot corresponding to modified code from the first file of the plurality of files, the modified code comprising a code modification modifying the original code;
generating, using a large language model (LLM), refactoring code based on the original code snapshot and the modified code snapshot, the refactoring code configured to apply the code modification to code from other files of the plurality of files associated with the original code;
identifying target code from a second file of the plurality of files, the target code associated with the original code; and
applying, using the refactoring code, the code modification to the identified target code of the second file of the plurality of files.

2. A computer-implemented method of claim 1, wherein a code functionality of the original code is the same as a code functionality of the modified code.

3. The computer-implemented method of claim 1, wherein:
the original code and the modified code each comprise respective code in a first programming language; and
the refactoring code comprises code in a second programming language different from the first programming language.

4. The computer-implemented method of claim 3, wherein the second programming language comprises a design specific language (DSL).

5. The computer-implemented method of claim 1, wherein the operations further comprise, before applying the code modification to the identified target code:
displaying, via a user device associated with a user, the refactoring code;
receiving, from the user device associated with the user, updated refactoring code comprising a user modification; and
applying, using the updated refactoring code, the code modification to the identified target code.

6. The computer-implemented method of claim 1, wherein the LLM comprises a pre-trained LLM.

7. The computer-implemented method of claim 1, wherein the operations further comprise training the LLM using labeled training samples, each respective labeled training sample comprising a corresponding training input paired with ground-truth refactoring code, the corresponding training input comprising training original code and training modified code.

8. The computer-implemented method of claim 7, wherein training the LLM using labeled training samples comprises, for each respective labeled training sample:
generating, using the LLM, predicted refactoring code based on the corresponding training input;
determining a training loss based on the predicted refactoring code and the paired ground-truth refactoring code; and
training the LLM based on the training loss.

9. The computer-implemented method of claim 8, wherein the ground-truth refactoring code comprises placeholders for capture variables.

10. The computer-implemented method of claim 1, wherein the operations further comprise:
determining a first Abstract Syntax Tree (AST) based on the original code snapshot;
determining a second AST based on the modified code snapshot; and
generating a comparison between the first AST with the second AST,
wherein the refactoring code generalizes the comparison between the first AST and the second AST.

11. A system comprising:
data processing hardware; and
memory hardware in communication with the data processing hardware, the memory hardware storing instructions that when executed on the data processing hardware cause the data processing hardware to perform operations comprising:
receiving an original code snapshot corresponding to original code from a first file of a plurality of files;
receiving a modified code snapshot corresponding to modified code from the first file of the plurality of files, the modified code comprising a code modification modifying the original code;
generating, using a large language model (LLM), refactoring code based on the original code snapshot and the modified code snapshot, the refactoring code configured to apply the code modification to code from other files of the plurality of files associated with the original code;
identifying target code from a second file of the plurality of files, the target code associated with the original code; and
applying, using the refactoring code, the code modification to the identified target code of the second file of the plurality of files.

12. A system of claim 11, wherein a code functionality of the original code is the same as a code functionality of the modified code.

13. The system of claim 11, wherein:
the original code and the modified code each comprise respective code in a first programming language; and
the refactoring code comprises code in a second programming language different from the first programming language.

14. The system of claim 13, wherein the second programming language comprises a design specific language (DSL).

15. The system of claim 11, wherein the operations further comprise, before applying the code modification to the identified target code:
displaying, via a user device associated with a user, the refactoring code;
receiving, from the user device associated with the user, updated refactoring code comprising a user modification; and
applying, using the updated refactoring code, the code modification to the identified target code.

16. The system of claim 11, wherein the LLM comprises a pre-trained LLM.

17. The system of claim 11, wherein the operations further comprise training the LLM using labeled training samples, each respective labeled training sample comprising a corresponding training input paired with ground-truth refactoring code, the corresponding training input comprising training original code and training modified code.

18. The system of claim 17, wherein training the LLM using labeled training samples comprises, for each respective labeled training sample:
generating, using the LLM, predicted refactoring code based on the corresponding training input;
determining a training loss based on the predicted refactoring code and the paired ground-truth refactoring code; and
training the LLM based on the training loss.

19. The system of claim 18, wherein the ground-truth refactoring code comprises placeholders for capture variables.

20. The system of claim 11, wherein the operations further comprise:
determining a first Abstract Syntax Tree (AST) based on the original code snapshot;
determining a second AST based on the modified code snapshot; and
generating a comparison between the first AST with the second AST,
wherein the refactoring code generalizes the comparison between the first AST and the second AST.
